(19) United States
(12) Patent Application Publication
(10) Pub. No.: US 2014/0074642 A1
(43) Pub. Date: Mar. 13, 2014

(54) INTERNET DISCOUNTED VOLUME PRICING SYSTEM

(71) Applicant: Derek Adam Brookmeyer, Woodstock, GA (US)

(72) Inventor: Derek Adam Brookmeyer, Woodstock, GA (US)

(73) Assignee: Squaboo, Inc., Woodstock, GA (US)

(21) Appl. No.: 14/018,327

(22) Filed: Sep. 4, 2013

Related U.S. Application Data
(60) Provisional application No. 61/696,344, filed on Sep. 4, 2012.

(51) Int. Cl. G06Q 30/08

(52) U.S. Cl. CPC G06Q 30/08
USPC 705/26.3

(57) ABSTRACT

Internet discounted volume pricing with early participation discounting or “Jump-in Pricing” feature in which a person with quantities of a product/services to sell is prompted to enter in some price points on a website for a defined amount of time. As an individual or group of buyers buy/participate in a listing, the price of that product/service declines. The current price is the price that the seller will not pay more than (excluding shipping and taxes if applicable). The sell-out price is the lowest possible price a buyer or collection of buyers will pay (excluding shipping and taxes if applicable) if the entire quantity sells out. The seller offers “Jump-in Pricing” which is a discount to early participants/buyers of a listing to provide an incentive to a person or person(s) to get in early and start the pricing reduction.

### PRIORITY

This application claim priority to U.S. Provisional Patent Application No. 61/696,344 filed Sep. 4, 2013, which is incorporated by reference.

### TECHNICAL FIELD

The invention relates to electronic commerce systems and, more particularly, to an electronic process of offering bulk discount pricing to an individual or group of individuals based on a mathematical formula that is updated with price points input by a seller. This process is highlighted by the necessary offer of “Jump-in Pricing” to early participants/buyers of a listing.

### BACKGROUND OF THE INVENTION

It is common practice in the business world for people to negotiate break point or volume related discounts. In the 1990's during the technology boom, several websites emerged offering the opportunity to pool individuals together to receive discounted volume pricing. Currently there are four popular pricing models on the Internet including auction pricing, fixed pricing, bid buying, and group deals.

Auction pricing has a seller list a product at a specified price. Sellers then decide whether the initial price is amenable or not. The seller can enter a maximum price they are willing to spend or enter a price and follow the auction's bidding (putting off the decision to bid again to a later time before the listing is over). As other sellers bid on the product, the price goes up. Once the auction has concluded, the buyer that has bid the highest price is awarded the product. Primary example is e-bay.com. It is possible for a buyer to buy the same product on multiple auction listings and pay a different price for each product.

Fixed pricing is a method where a seller lists a product at a set price. Sellers decide on whether or not that price is agreeable or a fair market price for that product. Regardless of quantity purchased, the buyer pays the same price for each product.

Bid buying is a method where buyers must purchase bid units in order to participate in a listing. Each time someone bids on an item to raise the price by 1 cent it costs them one bid unit which can cost up to $1.00. This can lead to an exponential amount of money being paid for a product. Also, it often isn't clear to users who won the bidding.

Group deals are items or services listed at a discounted price by a local merchant. Most of these websites are broken into regional areas so that people will have access to the good or service. A daily offer is sent out to registered users. The offering has a time limit and a set quantity listed. Once the entire quantity is sold or the time has expired, the deal ends. The user can purchase the offering and is issued a voucher via e-mail. This voucher is then redeemed for the product or service at the local merchant. The issues with this type of offering is that it is narrow in scope (one product offering per day) and the seller generally pays a very high “commission” for this type of offering. The quantity discount model as a stand-alone website was quite prominent in the 1990's and was very unsuccessful.

### SUMMARY OF THE INVENTION

The “jump-in pricing” system provides a solution to the type of internet selling models described above by implemented discounted volume pricing with Jump In Pricing. This model may be implemented in an Internet discounted volume pricing system in which a seller lists a quantity of a particular product or service and is prompted to answer a few basic questions. Based on how those questions are answered, pricing for each unit sold is determined. The more units sell, the closer the cost for the entire group falls towards the sell-out price (price per unit if the entire quantity is sold). At the conclusion of the listing, which occurs either when the entire quantity is sold or the time limit has expired, the final pricing is determined. Each person that has bought into the listing receives the lowest price point regardless of when he/she entered the listing.

A concern with this model as a stand-alone website is that most buyers will wait and see if other people will participate to start the price decline. As it turns out, most listings will not have participation without an incentive. The Jump-in Pricing option allows the seller to offer discounts to a defined number of early buyers of a listing. This will prompt people to participate in a listing early to get the added bonus of an additional discount. In turn, the price decline will commence with the early participants driving the price point down.

The drawings and following narrative will further demonstrate the invention and all claims related to the outlined invention. The drawings will merely illustrate the function of the invention and the nuances that make it unique. The specific techniques for accomplishing the advantages described above will become apparent from the following detailed description of the embodiments and the appended drawings and claims.

### BRIEF DESCRIPTION OF THE DRAWINGS

FIG. 1 is a block diagram that illustrates a view of a user interface interacting with a server in accordance with one aspect of the present invention.

FIG. 2 is a block diagram that illustrates buyers and sellers interacting via a server(s) in accordance with one aspect of the present invention.

FIG. 3 illustrates a diagram of a buyer and seller process flow in accordance with one aspect of the present invention.

FIG. 4 is a logic flow diagram that illustrates a buying process in accordance with one aspect of the present invention.

FIG. 5 is a logic flow diagram that illustrates a selling process in accordance with one aspect of the present invention.

FIG. 6 is a logic flow diagram that illustrates an overview of a pricing process in accordance with one aspect of the present invention.

FIG. 7 a logic flow diagram that illustrates a post listing process in accordance with one aspect of the present invention.

FIG. 8 is a simplified example of a product listing user interface in accordance with one aspect of the present invention.

FIG. 9 is a graph illustrating a linear volume pricing discount schedule in accordance with one aspect of the present invention.

FIG. 10 is a simplified example of a dynamic offering user interface in accordance with one aspect of the present invention.

FIG. 11 is a logic flow diagram illustrating a process for conducting a volume discount offering with a jump-in pricing discount feature in accordance with one aspect of the present invention.

### DETAILED DESCRIPTION OF THE EMBODIMENTS

In the Internet Discounted volume pricing with early participation discounting/“Jump-in Pricing” feature, a person with quantities of a product/services to sell is prompted to enter in some price points on a website for a defined amount of time. As an individual or group of buyers buy/participate in a listing, the price of that product/service declines. The current price is the price that the seller will not pay more than (excluding shipping and taxes if applicable). The sell-out price is the lowest possible price a buyer or collection of buyers will pay (excluding shipping and taxes if applicable) if the entire quantity sells out. In order for this business model to be successful, the seller offers “Jump-in Pricing” which is a discount to early participants/buyers of a listing to provide an incentive to a person or person(s) to get in early and start the pricing reduction. If that incentive isn't offered, it is likely that buyers will not participate as willingly until others participate/buy the product listing which will likely lead to little or no participation of a listing. Upon conclusion of the product/services listing the final prices are determined based on the sellers price points entered in when initially listing the product/service. All buyers of the product/service will pay the same final price except for those that participated early in a listing and received “Jump-in Pricing” discounts were applicable.

The Internet volume discount pricing system may be implemented through a website that brings buyers and sellers together with the goal of providing volume discounted pricing to an individual or group of buyers. Each listing is unique and provided an identifier on a host server. A mathematical formula is used to determine pricing for each unit sold based on how the seller answers questions when listing a product/service for sale. Access is granted to the website to potential buyers and sellers. In order to buy or sell a product or service, a user must register for the website. The criteria are terms and conditions for the website. Buyers may make a decision on whether or not to participate in a listing. The final price of a product is determined for all buyers of a particular listing at the conclusion of the listing (which is either determined by length of time defined by the seller or sell-out of the entire quantity) less any early participation discounting/“Jump-in Pricing” discounts that were offered to a pre-defined number of buyers. Payments are processed and deposited at the conclusion of the listing. The seller must have more than one of a particular product/service for sale, a price per unit if only one item is sold and a price per unit if the entire quantity is sold.

A mathematical formula is utilized to calculate the price per unit for all quantities sold in between. The listing of a product/service allows a potential buyer to input quantity desired, view the current price, sell-out price, if early participation discounting/“Jump-in Pricing” is available and any other details about the product/service. The system allows the seller to sell the product/service to a buyer that has participated in a listing at a price no higher than the current price less any early participation discounting/“Jump-in Pricing” discounts. (not including shipping or taxes if applicable). The seller defines an amount offered of a particular product/service available for a pre-defined amount of time during the listing process. The website may be made up of a collection of product/service offerings that are organized by categories.

The Internet volume discount pricing system includes a computer program that allows sellers to list products/services for sale by entering in various price points and quantity available, offering early participation discounting/“Jump-in Pricing” discounts of a listing, buyers the opportunity to participate in the purchase of a desired quantity of said product/service, inputting the quantity of the product/service desired on a specific listing, having the current price recalculate based on the seller's pricing structure. At the conclusion of a listing (determined either by an entire quantity of a listing selling out or the time limit of a listing that is defined by the seller expiring), the final price is set. A computer generated process allows volume pricing discounts with early participation discounting/“Jump-in Pricing” offers to early participants, registered buyers to participate in the purchase process, congregating buyers together to pool into larger groups of purchasing power, final costs being determined at the conclusion of a listing, payments processed, and products delivered to buyer(s) per the terms of the listing.

The Discounted volume pricing with Jump-in Pricing process may be implemented as follows. The system allows sellers to offer quantities of a product or service in one convenient listing. Buyers are able to purchase one or multiple items and have a direct impact on the price. Early buyers may be eligible for Jump-in Pricing discounts if offered by a seller. In doing so, this will allow the pricing to decrease for a listing while rewarding the early participants in a listing. This process if facilitated on a website hosted on a server.

In the Discounted volume pricing with Jump-in Pricing process, the seller lists a product for sale for a set amount of time and is prompted for some basic information about the item for sale. One such item is the Jump-in Pricing discount option. This will allow the seller to define a set amount of the earliest buyers an additional discount or reward above and beyond the volume discount pricing. Once that information is entered into the website, the system hosted on a server will generate a price per unit for all items sold. As more products in a listing are sold the price for all buyers in that particular listing will fall. A registered buyer will enter the quantity desired. A single buyer can buy the entire quantity or some lesser portion. Various price points are listed on the website so that a buyer can ascertain the lowest price possible on a listing and the maximum price that will be paid. One of two things will trigger the end of the listing. The time limit expires or the entire quantity has been sold. Once the listing is closed, the final price is calculated based on the number of units sold. All buyers in the listing will pay the same price except those that qualified a Jump-in Pricing discount. The jump-in pricing discount eligible buyers will pay the final price less the Jump-in Pricing discount.

As a single buyer or collection of buyers, participate in a listing the collective price will fall for the entire quantity purchased. If nine units are purchased by an individual or group of buyers, then all 9 units will fall to a set price. A pricing system hosted on a server will calculate the pricing for each product electronically. If a tenth item is purchased, then all ten units will fall collectively to a lower price. The early participants of a listing maybe be rewarded with additional discounts or rewards based on the seller pre-defined jump-in pricing discount.

A seller will offer a product electronically and will input price points based on quantities sold. A determination is made in regard to what kind of reward/discount will be offered to an initial group of buyers (Jump-in Pricing) A pricing structure is calculated by an algorithm hosted on a server using a formula that will have decreasing pricing for each unit sold. Once the seller's listing is finalized, buyer(s) will begin to place orders for the product. The final price point is identified by the pricing algorithm hosted on a server and determined to be the total quantity of an item ordered with the corresponding price point in the above mentioned pricing schedule. The final price point for that total quantity ordered is the price for the each buyer whether that is an individual or a group of buyers. In addition, Jump-in Pricing discounts will be applied via a pricing formula hosted on a server, to the eligible early buyers of a listing.

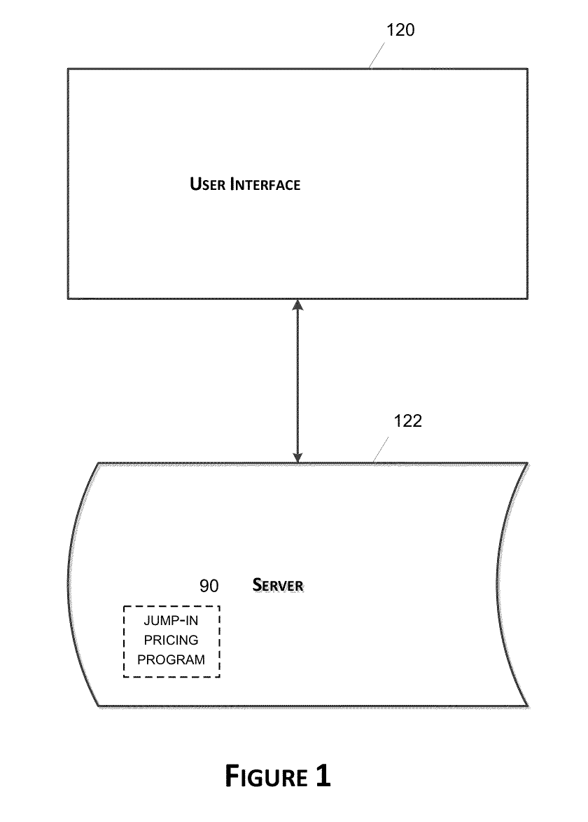

Referring now to the figures, FIG. 1 is a block diagram that illustrates a view of a user interface interacting with a server in accordance with one aspect of the present invention. A user 120 interacts with a Server 122 that hosts a series of commands processed by a central processor that implements a jump-in pricing program 90 that implements the volume discounted pricing with the option to offer jump-in pricing discounts.

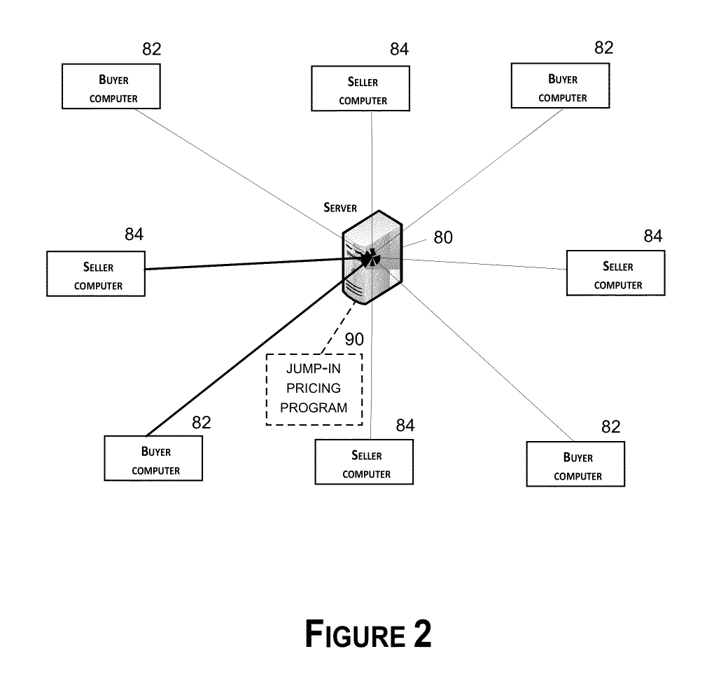

FIG. 2 is a block diagram that illustrates buyers and sellers interacting via a server(s) in accordance with one aspect of the present invention. As shown in FIG. 2, buyer computer stations 82 (also referred to as buyers) and seller computer stations 84 (also referred to as buyers) interact with the server 80 via any suitable network, such as the Internet. The server 80 hosts the jump-in pricing program 90, which is processed by the central server 80. Buyers and sellers interface with the servers via a keyboard, mouse or other suitable input-output devices. The server stores registered user data, transactions, and seller listings. The jump-in pricing program 90 calculates pricing based on seller inputs and price points established during the listing process using an algorithm and items eligible for jump-in pricing discounts.

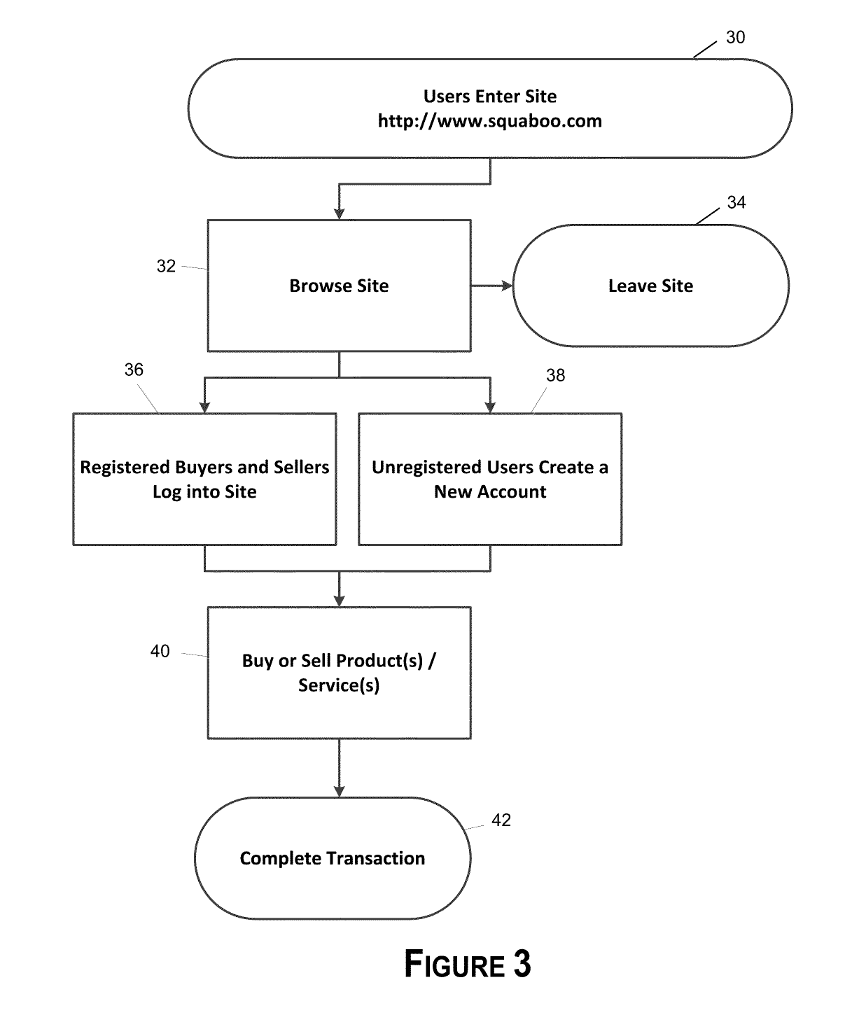

FIG. 3 illustrates a diagram of a buyer and seller process flow in accordance with one aspect of the present invention, in which a user interfaces with a website 30 to access the jump-in pricing program 90. In step 32, the user can browse the site. If the user does not find a product/service to purchase, the user may leave the site in step 34. If the user decides to buy or sell on the site, in step 36 the existing user will sign in using a predefined username and password established during a previous visit to the site stored on a server. In step 38, new users to the site will create a user account. If the buyer or seller decides to proceed, the user will buy or sell product(s) or service(s) in step 40. The user will complete the transaction in step 42 by agreeing to comply to the terms of the site.

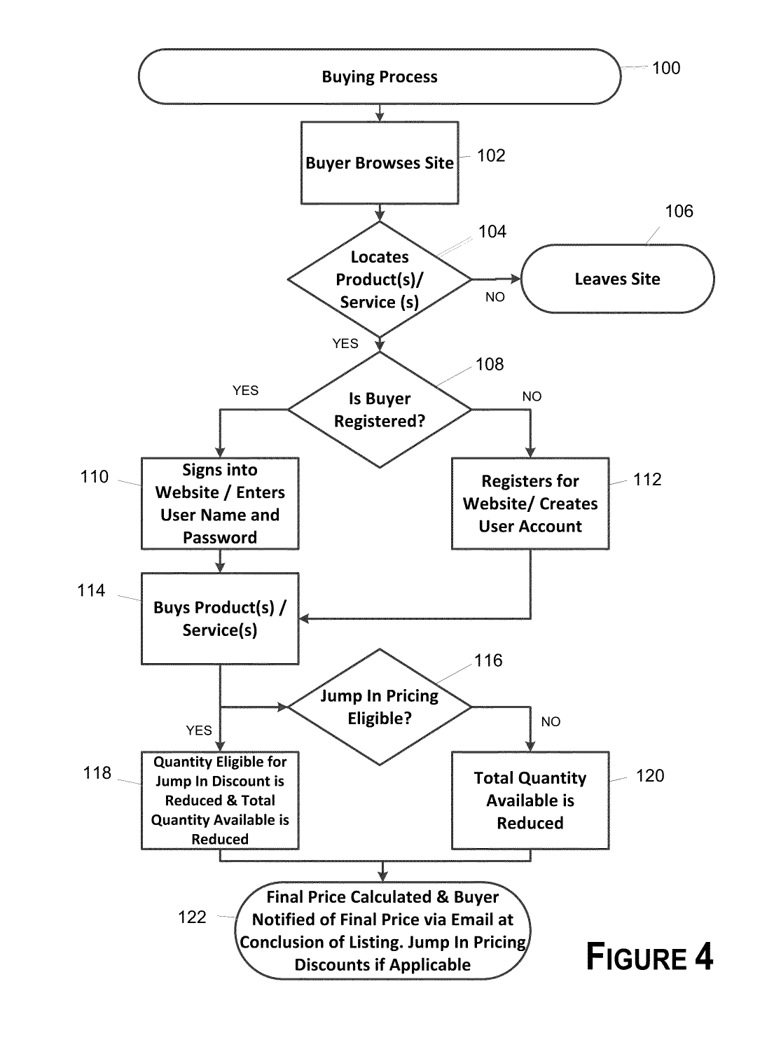

FIG. 4 illustrates the buying process 100 for a website running the jump-in pricing program 90. A buyer browses the site in step 102 seeking product(s) and/or service(s). If the prospective buyer is unable to locate item(s) to buy, the user can elect to leave the site in step 106. If the user is able to find product(s) or service(s) to purchase, the user must either log in using a predefined username and password in step 110 or create a user account in step 112. The buyer then elects the quantity of items to purchase in step 114. The jump-in pricing program 90 hosted on a server will electronically calculate using an algorithm and reduce the price by a predefined amount based on the seller's inputs. In step 116, the jump-in pricing program 90 determines whether the product is jump-in pricing eligible. If so, the jump-in pricing program 90 determines the quantity eligible for jump-in pricing and the total quantity are both reduced in step 118. If the items are not eligible for jump-in pricing discounts, the jump-in pricing program 90 reduces the total quantity in step 120. At the conclusion of the listing, the jump-in pricing program 90 calculates a final price and notifies the buyer(s) of the pricing in step 122. As a result, the jump-in pricing program 90 applies jump-in pricing discounts where applicable.

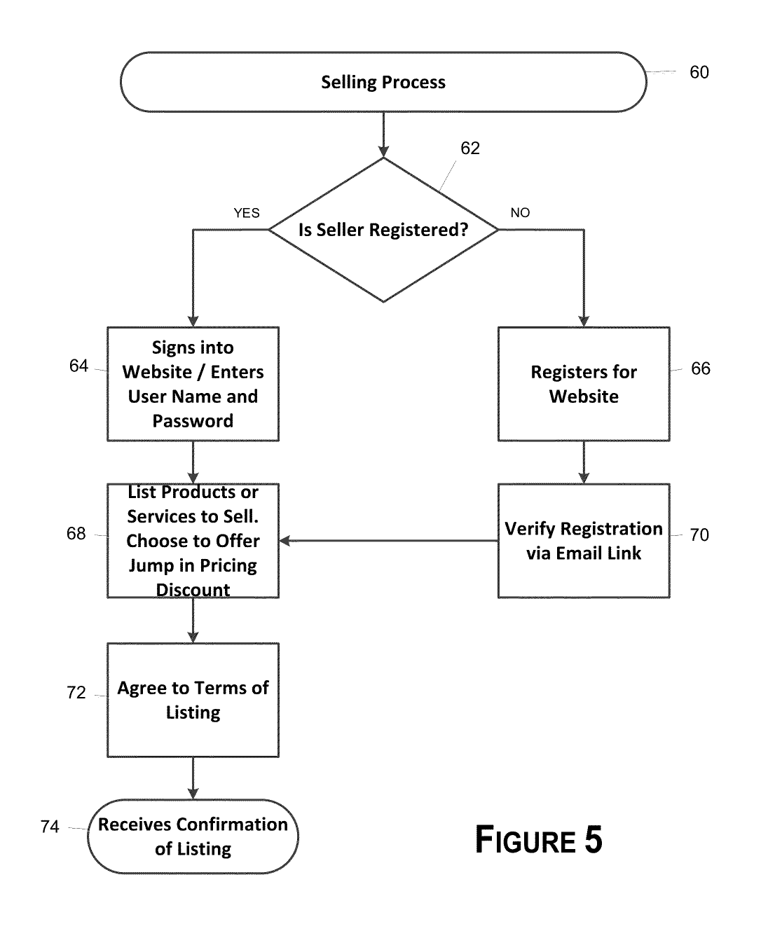

FIG. 5 is a logic flow diagram that illustrates a selling process in accordance with one aspect of the present invention. A seller enters the website to create a listing in step 60. A new user must register for the site to list product(s) and/or service(s) for sale in step 62. The existing user logs into the site using a predefined username and password in step 64. The new seller must create a user account in step 66. The seller will follow the prompts and enter in pricing and product/service data in step 68. The user will have the option to offer jump-in pricing discounts, define pricing, length of listing, and other pertinent information. User agrees to terms of use of site in step 72. The user will receive a confirmation of the listing in step 74.

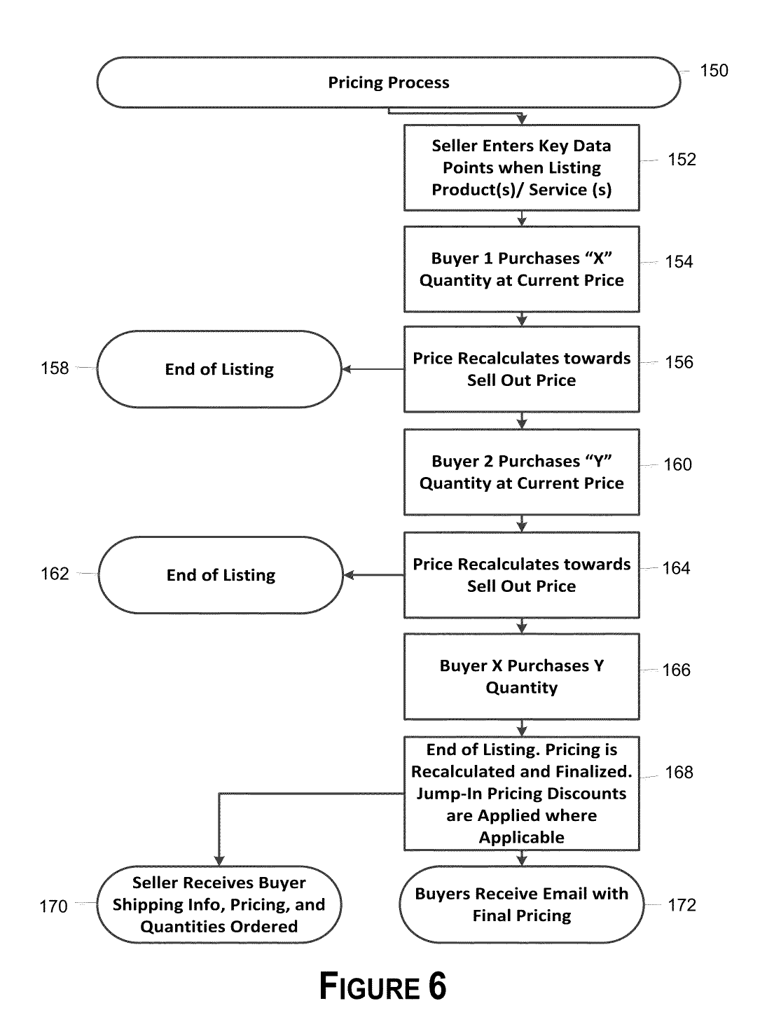

FIG. 6 is a logic flow diagram that illustrates an overview of a pricing process in accordance with one aspect of the present invention. The pricing process 150 is determined by the seller defined data points when listing on the site in step 152. As buyer 1 purchases a defined quantity in step 154, the jump-in pricing program 90 recalculates and lowers the price closer towards the sell-out price. If the quantity sells out or the time expires, the jump-in pricing program 90 ends the listing in step 158. If time is still available and quantity still remains, the listing will continue. As buyers purchase on a listing, the jump-in pricing program 90 repeats this process until either the time expires or quantity is sold out. At the conclusion of the listing, pricing is calculated and finalized by the jump-in pricing program 90. Any jump-in pricing discounts (if applicable) are applied by the jump-in pricing program 90 in step 168. In step 170, the jump-in pricing program 90 notifies the seller indicating the successful buyers, items purchased, quantities ordered, and pricing. In step 172, the jump-in pricing program 90 notifies the buyer(s) with final pricing and purchase details.

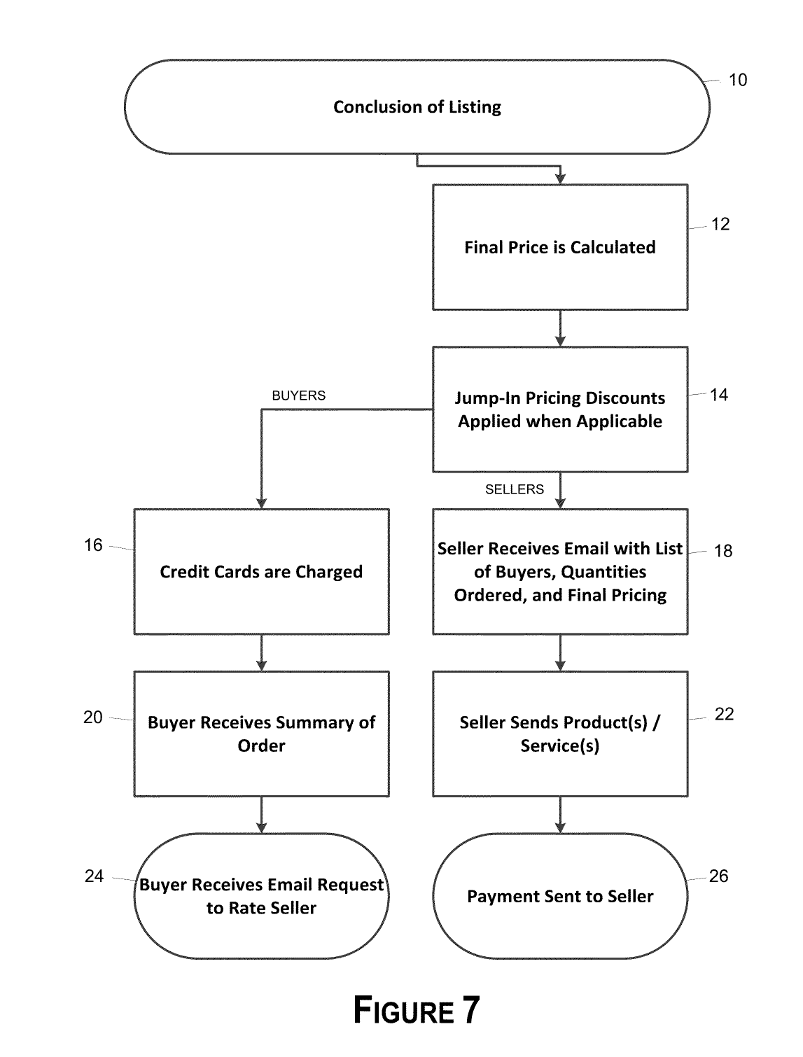

FIG. 7 a logic flow diagram that illustrates a post listing process in accordance with one aspect of the present invention. Conclusion of listing diagram 10 is caused by one of two events: (a) the expiration of the listing time, or (b) the quantity sells out (whichever event happens first). In step 16, the jump-in pricing program 90 hosted on the server 80 calculates the final pricing for the buyers in step 12. If applicable, the jump-in pricing program 90 applies the jump-in pricing discounts to eligible buyers in step 14. In step 18, the jump-in pricing program 90 notifies the seller and provides a summary of listing purchases with information such as buyers, quantities ordered, and pricing. In step 20, the jump-in pricing program 90 notifies the buyers, charges the buyers the final price, and sends a summary/receipt of the transaction. The seller, seller's agent, or a third-party facilitator then sends the product(s) or service(s) to the buyers 22. The jump-in pricing program 90 may also send the buyer a request to rate seller and the transaction experience in step 24. Payment is sent to the seller upon successful completion of the transaction in step 26.

To provide just a few example featured of the system, the user may also select a category for the product(s) or service(s) to facilitate items to be grouped. This process may enable more efficient search functionality on the server. The search engine function can be further enhanced by the seller selecting a sub-category of the previously selected category. A product headline may also be entered to give prospective buyers a general understanding of the listing. A subtitle can also accompany the product headline. If applicable, a user may display the brand name as an effective tool to market the product(s) or service(s). Further detail to a listing can be added, such as the model number, style of the item(s), whether the item is new or refurbished, and so forth. The seller may also provide narrative with further information and links to provide additional information to potential buyers . A menu driven user interface may allow the seller may to associate products with categories, pictures, descriptions, and other relevant information. A user can also upload or link to a picture of the product or service to catch the eye of potential buyers.

The seller may also be able to define multiple sales with similar or different durations, for example by specifying the day, month, year, time, and other offering parameters for each offering. The listing process may be facilitated with user interface panels, menus, and prompts. For example, the seller may be prompted to enter the quantity offered, price if one item is sold, if all items offered are sold, the volume discount and the jump-in pricing discounts. If jump-in pricing discounts are to be offered, the seller may be prompted to define the number of eligible items for the early discounts and how much that discount will be. Other costs, such as shipping, will further be identified and quantified by the seller. The seller may also provide a return policy and define additional the terms of the sale, as desired. Buyers and seller must typically agrees to the terms of the site in order to register and participate. Upon agreement of the terms and successful completion of the form with all required data points entered, the listing will post to the site. Many other features found to be customary and convenient for other online commerce sites may be implemented, as desired.

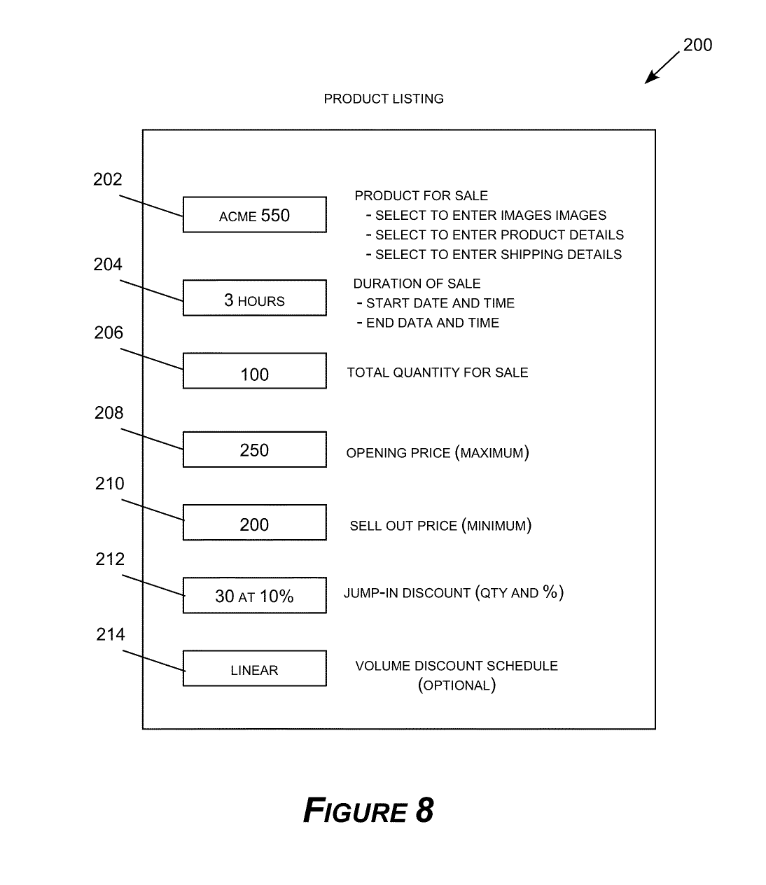

FIGS. 8-11 illustrate a simplified example of user interfaces and procedure implemented by the jump-in pricing application 90 to implement an embodiment of the invention. While many other features and options may be included, these figures are intended to point out and highlight only those features that distinguish the jump-in pricing application 90 from other online commerce systems. It will be appreciated that more sophisticated features, such as non-linear volume pricing discounts and variable jump-in pricing discounts, may be implemented along with a wide range of other online commerce features.

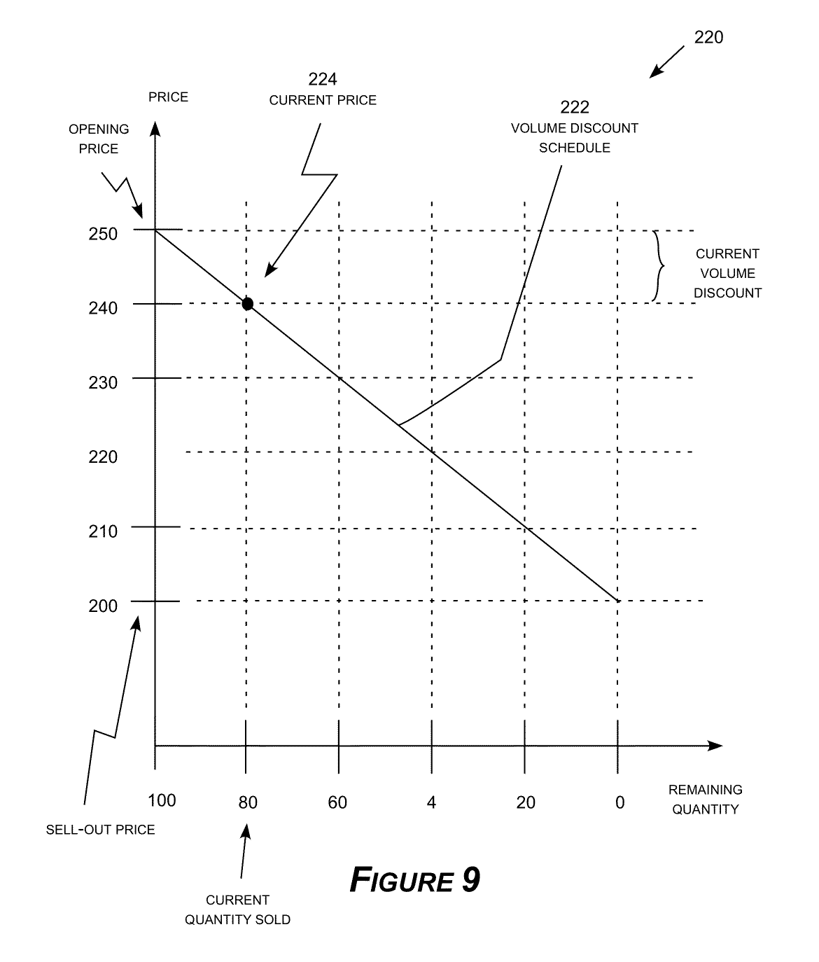

FIG. 8 is a simplified example of user interface 200 exposed by the jump-in pricing application 90 that a seller may utilize top define a volume discount pricing offering in accordance with an embodiment of the invention. While this example utilizes semi-structured fields, any other suitable user interface technique may be utilized to obtain similar information. In this example, the seller enters a product identification into field 202 and additional information and links to product details, such as images, descriptions, and shipping information. The seller enters a duration for the offering into field 204 and additional scheduling information for the offering, such as a starting time and date and an ending time and date. The seller enters a quantity for the offering into field 206 and the opening price for offering into field 208, which is the price of the first unit sold without any volume discount. The seller also enters a sell-out price for the offering into field 210, which is the minimum price that will be charged for all units sold if the full quantity of the offering is sold. In field 212, the seller also enters a jump-in discount including a quantity and a percentage discount that is offered, in addition to the volume discount, for early buyers to encourage them to “jump in” to get the buying started. The seller may also enter a volume discount schedule into field 214, for example by defining or selecting from available schedules. This example utilizes a linear volume discount schedule, as shown in FIG. 9 for the example defined by the entries shown in FIG. 8.

FIG. 9 is a graph 220 illustrating a linear volume pricing discount schedule 222 for the example shown in FIG. 8 in which the opening price is $250, the quantity is 100, and the sell-out price is 200. The produces the linear volume pricing discount schedule 222. Each buyer, regardless of the current price at the time they submit a purchase, receives the end price for the offering. The linear volume pricing discount schedule causes the current price to decline in response to each purchase to encourage additional buyers to submit purchases to drive the price down toward the sell-out price. The jump-in discount is provided in addition to the volume pricing discount for those buyers who “jumped in” with the early purchases.

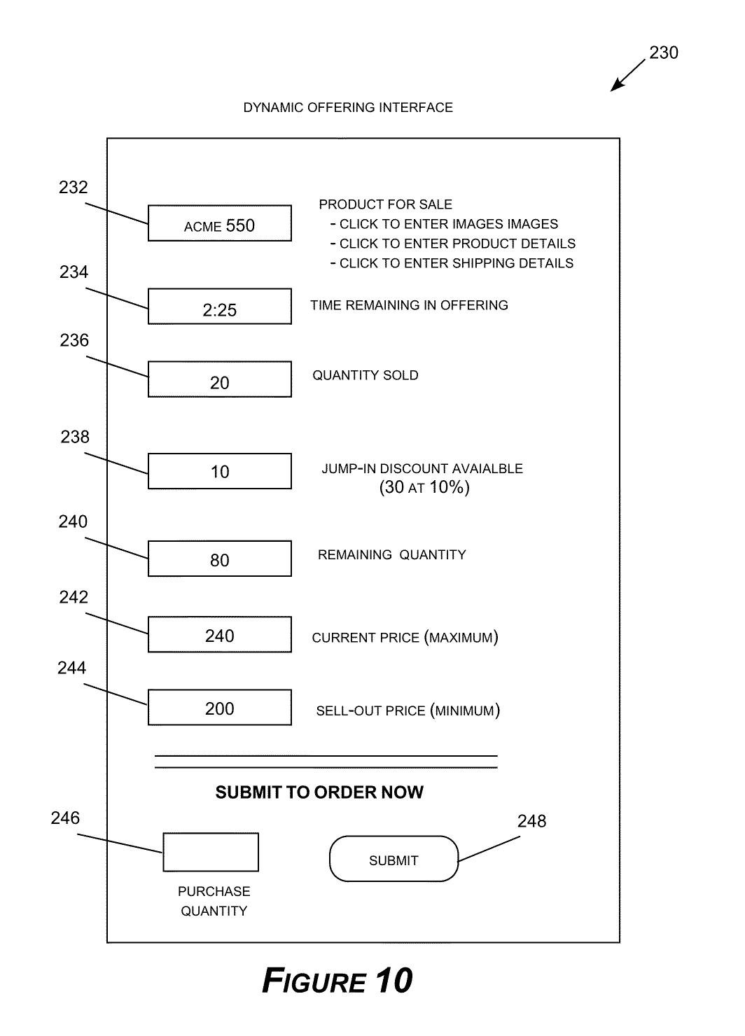

In order for prospective sellers to be enticed to make purchases during the offering, they must be made aware of the quantity, price and discount values as those figures change over the course of the offering. This is provided through a dynamic offering interface that is displayed and continually updated during the course of the offering. FIG. 10 is a simplified example of a dynamic offering user interface 230, which shows values corresponding to the current price 244 shown in FIG. 9. That is, the dynamic offering user interface 230 is updated after each sale is submitted to reflect the current price and remaining discounts and quantity available in the offering. FIG. 10 shows a “snap shot” of the dynamic offering user interface 230 after 20 units have sold. A product field 232 identifies the product for sale in the offering alone with links to the additional information provided by the seller, such as images, descriptions and shipping details. The duration field 234 indicates that 2 hours and 25 minutes remain in the offering, which in this example had an original duration of 3 hours. The quantity sold field 236 indicates that 20 units have sold so far. The jump-in pricing field 238 indicates that 10 jump-in pricing discounts are still available and also shows the total number and percentage amount (30 at 10%) of the jump-in discount. The remaining quantity field 240 indicates that 80 units remain for sale of the 100 units originally included in the offering. The current price field 242 indicates that the current price (reflecting the volume discount based on the quantity sold so far) is $240, which corresponds to the current price 224 shown in FIG. 9. The sell-out price (in this example $200) is also displayed in the sell-out price field 244.

The dynamic offering interface further exposes a quantity purchase field 246 and a submit button 248 allowing prospective purchasers to enter purchases. The dynamic entries in these fields are continually updated during the offering to provide prospective buyers with real-time information regarding the current state of the offering. Providing these information updates while the offering is in process encourages additional buyers to submit purchases to drive the price down further toward a complete sell-out, which minimizes the price at the sell-out price 244. As noted, all purchasers receive the benefit of the full volume discount generated at the end of the offering, regardless of what the current value was when they submitted their purchase. However, only those early purchaser who submitted their purchases while the jump-in discount was available receive the additional jump-in discount on top of the final volume discount generated at the end of the offering.

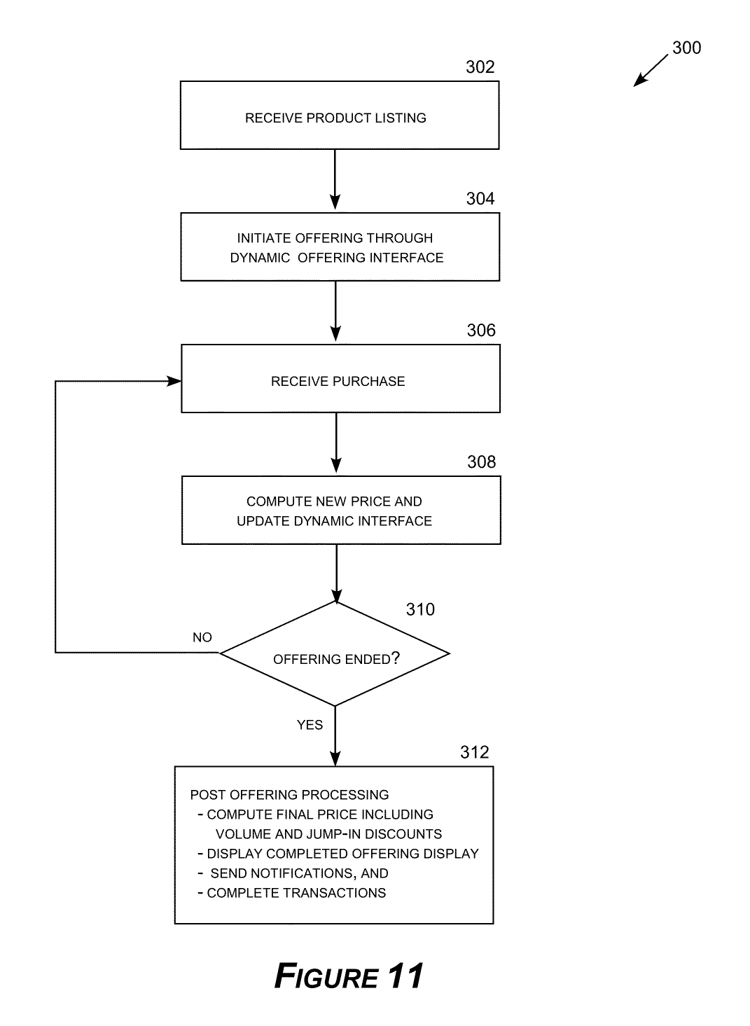

FIG. 11 is a logic flow diagram illustrating a process 300 for conducting a volume discount offering with a jump-in pricing discount feature which, in this example, is performed by the jump-in pricing application 90. In step 302, the application receives a product listing such as the example shown in FIG. 8. Step 302 is followed by step 304, in which the application initiates the offering through a dynamic offering interface, such as the example shown in FIG. 10. Step 304 is followed by step 306, in which the application receives a purchase through the offering. Step 306 is followed by step 308, in which the application computes a new price based on the volume discount, such as in the example shown in FIG. 9, and updates the dynamic offering interface. Step 308 is followed by step 310, in which the application determines whether the offering has ended, typically because the full quantity of the offering has been sold or the duration of the offering has expired. It should be noted that expiration of the duration of the offering will also cause the offering to end even if the expiration does not coincide with a purchase.

If the offering has not ended, the “no” branch is followed from step 310 to step 306, in which the application may receive another purchase. If the offering has ended, the “yes” branch is followed from step 310 to step 312, in which the application performs post offering processing, which includes computing the final price based on the total volume discount applied for the total number of sales during the offering and affords the total volume discount to each purchase submitted during the offering. The application also applies the jump-in price discount in addition to the total volume discount for qualifying buyers. The application typically displays a completed offering panel to publicize the successful completion and results of the offering, notifies the seller and buyers of the results, and completes the transactions as needed.

The present invention may consist of (but is not required to consist of) of adapting or reconfiguring presently existing systems. Alternatively, original equipment may be provided embodying the invention. All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is further contemplated that each of the embodiments of the method described above may include any other step(s) of any other method(s) described herein. In addition, each of the embodiments of the method described above may be performed by any of the systems described herein.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile or non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A non-transitory computer storage medium comprising computer executable instructions for performing a method for selling items, comprising the steps of:
obtaining a listing for offering similar items for sale including an identification of the similar items and offering parameters including a maximum duration, an offering quantity, an opening price, a volume discount, and a number of jump-in price discounts available to initial purchasers of the items;
displaying a dynamic offering interface available to potential purchasers showing information identifying the item, the maximum duration, the offering quantity, the opening price, the volume discount, and the number of jump-in discounts available during the offering;
conducting an offering for the item in accordance with the offering parameters;
continually updating the dynamic offering interface while the offering is in progress to reflect a remaining quantity of items offered for sale during the offering, a remaining portion of the jump-in price discounts available to future purchasers, and a current price for the item based on the volume discount and a current number of items sold during the offering;
completing the offering due to expiration of the maximum duration or sale of the offering quantity of the items;
computing a final volume-discounted purchase price for the items based on the opening price, the volume discount, and the total number of items sold during the offering and assigning the final volume-discounted purchase price to all items sold during the offering except those qualifying for the jump-in discount;
computing a final jump-in discounted purchase price for the items based on the final volume-discounted purchase less the jump-in discount and assigning the final jump-in discounted purchase price to those items qualifying for the jump-in discount and
transmitting notifications to a seller associated with the listing and purchasers of the items reflecting the volume-discounted purchase price.

2. The computer storage medium of claim 1, wherein the volume discount varies as a function of the number of items sold.

3. The computer storage medium of claim 1, wherein the volume discount varies with each item sold.

4. The computer storage medium of claim 1, wherein the volume discount varies with each item sold.

5. The computer storage medium of claim 1, wherein the jump-in pricing discount is a constant value with respect to the number of items sold.

6. The computer storage medium of claim 1, wherein the method further comprises the step of displaying a completed offering panel to publicize the successful completion and results of the offering.

7. A computerized method for selling items, comprising the steps of: selling items, comprising the steps of:
obtaining a listing for offering similar items for sale including an identification of the similar items and offering parameters including a maximum duration, an offering quantity, an opening price, a volume discount, and a number of jump-in price discounts available to initial purchasers of the items;
displaying a dynamic offering interface available to potential purchasers showing information identifying the item, the maximum duration, the offering quantity, the opening price, the volume discount, and the number of jump-in discounts available during the offering;
conducting an offering for the item in accordance with the offering parameters;
continually updating the dynamic offering interface while the offering is in progress to reflect a remaining quantity of items offered for sale during the offering, a remaining portion of the jump-in price discounts available to future purchasers, and a current price for the item based on the volume discount and a current number of items sold during the offering;
completing the offering due to expiration of the maximum duration or sale of the offering quantity of the items;
computing a final volume-discounted purchase price for the items based on the opening price, the volume discount, and the total number of items sold during the offering and assigning the final volume-discounted purchase price to all items sold during the offering except those qualifying for the jump-in discount;
computing a final jump-in discounted purchase price for the items based on the final volume-discounted purchase less the jump-in discount and assigning the final jump-in discounted purchase price to those items qualifying for the jump-in discount; and
transmitting notifications to a seller associated with the listing and purchasers of the items reflecting the volume-discounted purchase price.

8. The method of claim 7, wherein the volume discount varies as a function of the number of items sold.

9. The method of claim 7, wherein the volume discount varies with each item sold.

10. The method of claim 7, wherein the volume discount varies with each item sold.

11. The method of claim 7, wherein the jump-in pricing discount is a constant value with respect to the number of items sold.

12. The method of claim 7, wherein the method further comprises the step of displaying a completed offering panel to publicize the successful completion and results of the offering.

13. A computer implemented system for selling items, comprising a user interface accessible by potential purchasers over a network and a server configured to perform the steps of:
obtaining via the user interface a listing for offering similar items for sale including an identification of the similar items and offering parameters including a maximum duration, an offering quantity, an opening price, a volume discount, and a number of jump-in price discounts available to initial purchasers of the items;
displaying via the user interface a dynamic offering interface available to potential purchasers showing information identifying the item, the maximum duration, the offering quantity, the opening price, the volume discount, and the number of jump-in discounts available during the offering;
conducting an offering for the item in accordance with the offering parameters;
continually updating the dynamic offering interface while the offering is in progress to reflect a remaining quantity of items offered for sale during the offering, a remaining portion of the jump-in price discounts available to future purchasers, and a current price for the item based on the volume discount and a current number of items sold during the offering;
completing the offering due to expiration of the maximum duration or sale of the offering quantity of the items;
computing a final volume-discounted purchase price for the items based on the opening price, the volume discount, and the total number of items sold during the offering and assigning the final volume-discounted purchase price to all items sold during the offering except those qualifying for the jump-in discount;
computing a final jump-in discounted purchase price for the items based on the final volume-discounted purchase less the jump-in discount and assigning the final jump-in discounted purchase price to those items qualifying for the jump-in discount; and
transmitting notifications to a seller associated with the listing and purchasers of the items reflecting the volume-discounted purchase price.

14. The system of claim 13, wherein the volume discount varies as a function of the number of items sold.

15. The system of claim 13, wherein the volume discount varies with each item sold.

16. The system of claim 13, wherein the volume discount varies with each item sold.

17. The system of claim 13, wherein the jump-in pricing discount is a constant value with respect to the number of items sold.

18. The system of claim 13, wherein the method further comprises the step of displaying a completed offering panel to publicize the successful completion and results of the offering.
